(19) United States
(12) Patent Application Publication
(10) Pub. No.: US 2006/0155461 A1
(43) Pub. Date: Jul. 13, 2006

(54) POSITION INFORMATION SHARING SYSTEM AND METHOD USING MOBILE COMMUNICATION SYSTEM

(76) Inventor: SOON HAK CHO, Icheon-shi Kyungki-do (KR)

Correspondence Address: IPLA P.A., 3580 WILSHIRE BLVD., 17TH FLOOR, LOS ANGELES, CA, 90010, US

(21) Appl. No.: 11/163,998

(22) Filed: Nov. 7, 2005

(30) Foreign Application Priority Data
Jan. 7, 2005 (KR) 10-2005-0001453

(51) Int. Cl. G01C 21/26

(52) U.S. Cl. 701/207; 701/210; 701/213

(57) ABSTRACT

A position information sharing system and method using a mobile communication system is provided. The system includes: a plurality of navigation terminals for wirelessly communicating with the mobile communication system, receiving shared position information of at least one navigation system through the mobile communication system, mapping a self position and a position based on the received position information to map data, and displaying the mapped positions; and a service providing center for performing authentication for sharing of position information between the plurality of navigation terminals, receiving the shared position information from each of the navigation terminals when the authentication is made, and transmitting the received position information to the corresponding navigation terminals.

### BACKGROUND OF THE INVENTION

1. Field of the Invention

The present invention relates to a navigation system, and more particularly, to a position information sharing system and method using a mobile communication system, in which the position information can be shared by a plurality of navigation terminals, using the mobile communication system, so that one navigation terminal can display positions of other navigation terminals together.

2. Description of the Related Art

In recent years, a user using a navigation system installed at a vehicle and performing road guidance using a global positioning system (GPS) is rapidly increased in number.

The navigation system includes 24 GPS satellites; a GPS receiver for receiving a position signal and/or an absolute time signal from each of at least three ones of the GPS satellites; and a navigation terminal having map data on a road, a building, a mountain, and a river all over the country, and calculating a self position from the received GPS signals, mapping the calculated self position to the map data, and displaying the mapped data.

The navigation system receives an intermediate point and a destination from the user, selects a running path from a current position to the destination according to a path selecting method, maps the path to the map data, displays the mapped data, and guides a running direction of the navigation terminal to the destination on the basis of the path. As the path selecting method, there are a shortest path selecting method, an expressway-centered selecting method, and a national expressway selecting method.

In general, the navigation terminal of the navigation system is installed at a vehicle, and performs road guidance to allow the user to drive a car and arrive at the destination with speed and comfort.

As described above, the conventional navigation system has an advantage of convenience in that it can display the self position on the map and perform the road guidance to the destination even though the user, that is, a driver is not aware of a way to the destination.

However, the conventional navigation system displays only the self position on the map and therefore, may cause the following drawbacks.

The first is that since several persons ride and move on cars where the navigation terminals are not installed or only some of which has the navigation terminals installed, a driver of a preceding vehicle should pay attention so as to prevent a following vehicle from missing the preceding vehicle while driving to the destination. Further, there is a drawback in that a driver of the following vehicle drives unreasonably so as not to miss the preceding vehicle and therefore, ignores traffic lights.

The second is as follows. In case where the navigation systems are installed at all the cars, the destination should be inputted and the path should be set to each of the navigation terminals installed at the cars. However, there is a drawback in that, due to a different path selected by each vehicle at the time of setting the path, a time taken to arrive at the destination is different and it cannot be detected whether other vehicles are running in any area on the path to the destination and therefore, it is difficult for the drivers to do collective actions while the cars are running.

### SUMMARY OF THE INVENTION

Accordingly, the present invention is directed to a position information sharing system and method using a mobile communication system that substantially overcomes one or more of the limitations and disadvantages of the conventional art.

One object of the present invention is to provide a position information sharing system and method using a mobile communication system, in which the position information can be shared between a plurality of navigation terminals, using the mobile communication system, so that one navigation terminal can display positions of other navigation terminals together.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a position information sharing system using a mobile communication system, the system including: a plurality of navigation terminals for wirelessly communicating with the mobile communication system, receiving shared position information of at least one navigation system through the mobile communication system, mapping a self position and a position based on the received position information to map data, and displaying the mapped positions; and a service providing center for performing authentication for sharing of position information between the plurality of navigation terminals, receiving the shared position information from each of the navigation terminals when the authentication is made, and transmitting the received position information to the corresponding navigation terminals.

In another aspect of the present invention, there is provided a position information sharing system using a mobile communication system, the system including: a plurality of navigation terminals for wirelessly communicating with the mobile communication system, communicating shared position information of at least one navigation system through the mobile communication system, mapping a self position and a position based on the received position information to map data, and displaying the mapped positions; and a service providing center for performing authentication for sharing of position information between the plurality of navigation terminals, and connecting and controlling the navigation terminals to communicate their shared position information when the authentication is made.

In a further another aspect of the present invention, there is provided a navigation terminal of a position information sharing system using a mobile communication system, the terminal having a displaying unit and communicating shared position information having position information and path information between a plurality of navigation terminals, using the mobile communication system, the terminal including: a wireless communicating unit for communicating the shared position information; a GPS (global positioning system) receiver for receiving a GPS satellite signal; a map database for storing map data; a position information processor for receiving the GPS satellite signals under a predetermined control to calculate a self position, separating and analyzing the position information and the path information from at least one of the received shared position information, and mapping the self position and a position based on the received position information to the map data; and a controller for controlling the position information processor to receive and display the mapped data on the displaying unit.

In a yet another aspect of the present invention, there is provided a position information sharing method using a mobile communication system, the system having at least two navigation terminals for communicating shared position information and a service providing center for controlling authentication between the navigation terminals, the method including the steps of: in a predetermined first one of the navigation terminals, transmitting a position information sharing message that has a self inherent number and inherent numbers of second navigation terminals other than the first navigation terminal, to the service providing center through the mobile communication system; in the service providing center, receiving the position information sharing message, detecting the inherent numbers of the second navigation terminals, and transmitting the position information sharing message to the second navigation terminals having the inherent numbers; in each of the second navigation terminals, receiving the position information sharing message, and when a user gives permission to share the position information, transmitting a response message responsive to the permission, to the service providing center; and in the service providing center, upon reception of the response message, controlling and connecting the first navigation terminal and the second navigation terminals to transmit the shared position information between the first navigation terminal and the second navigation terminals.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a position information sharing system using a mobile communication system according to the present invention;

FIG. 2 illustrates a construction of a navigation terminal according to an embodiment of the present invention;

FIG. 3 is a process diagram illustrating a method for sharing position information between two navigation terminals according to an embodiment of the present invention;

FIG. 4 is a process diagram illustrating a method for sharing position information between two navigation terminals according to an embodiment of the present invention;

FIG. 5 is a flowchart illustrating a method of sharing position information in a navigation terminal according to an embodiment of the present invention;

FIG. 6 is a flowchart illustrating a method for displaying positions of a plurality of navigation terminals in a navigation terminal according to an embodiment of the present invention; and

FIG. 7 illustrates an example of displaying positions of a plurality of navigation terminals, depending on shared position information, on a displaying unit of a navigation terminal according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

In the present invention, position information is shared between a plurality of navigation terminals connected and mutually communicating with a mobile communication system, thereby displaying not only a self position but also positions of the plurality of navigation terminals on one map. As the navigation terminal connected with the mobile communication system and receiving a GPS signal from a GPS satellite and detecting and displaying the self position, there are a telematics terminal, a cellular phone having a navigation function, and a personal digital assistant (PDA) connected with the mobile communication system and having the navigation function. A detailed description based on the telematics terminal will be made with reference to the attached drawings below.

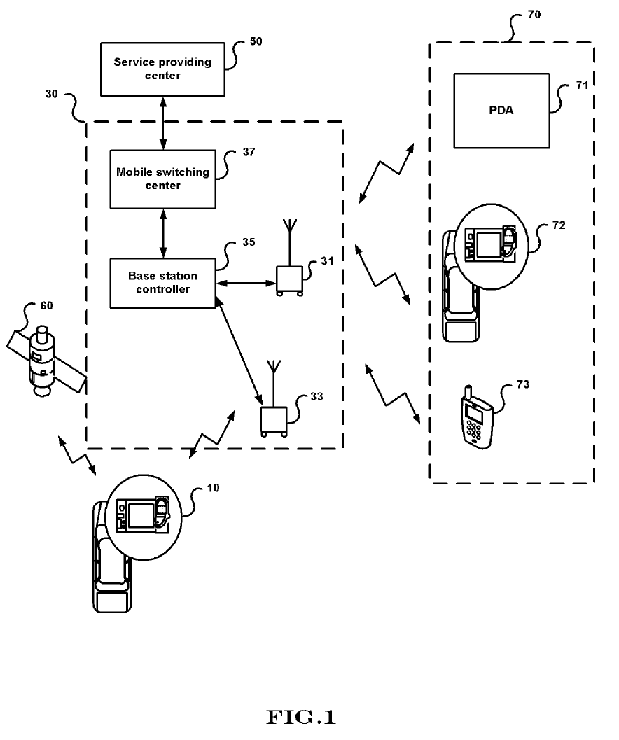

FIG. 1 illustrates a construction of a position information sharing system using the mobile communication system according to the present invention.

Referring to FIG. 1, a reference numeral 10 denotes the telematics terminal, a reference numeral 30 denotes the mobile communication system, and a reference numeral 70 denotes collection of the navigation terminals connectable with the mobile communication system 30. FIG. 1 distinguishes and illustrates the telematics terminal 10 and the navigation terminal 70 in order to distinguish a navigation terminal requesting to share the position information from a navigation terminal responding to the request for sharing the position information. Accordingly, the navigation terminal 70 is used as a term including all the PDA 71, the telematics terminal 72, and the cellular phone 73.

The inventive position information sharing system includes the mobile communication system 30, a service providing center 50, and the navigation terminals 10 and 70.

The mobile communication system 30 includes a plurality of base stations 31 and 33, a base station controller 35 for controlling the base stations, and a mobile switching center 37, to wirelessly communicate voice and data between the navigation terminals 10 and 70.

The service providing center 50 provides various additional services, and controls a service authentication and an inter-terminal authentication when providing the additional services. In the present invention, when the telematics terminal 10 requests for sharing the position information, the service providing center 50 transmits the position information to the navigation terminals 70 desiring the sharing of the position information, and controls only the desiring navigation terminal 70 to share the position information.

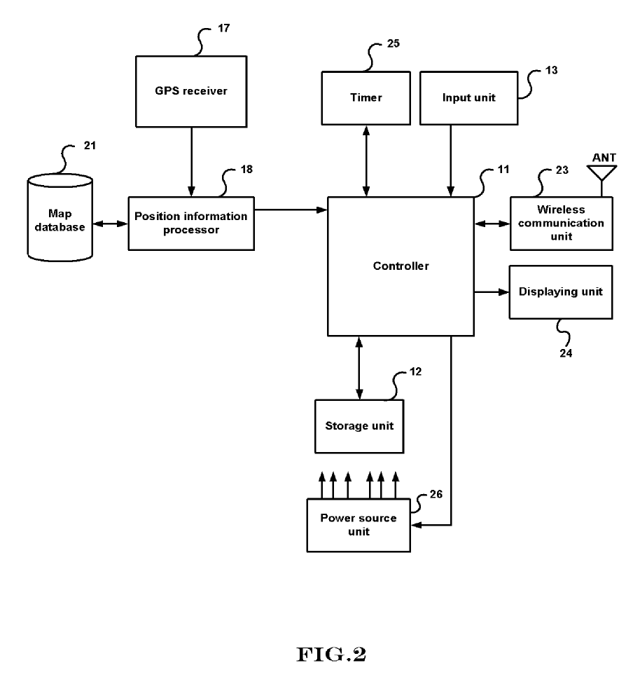

FIG. 2 illustrates a construction of the navigation terminal 70 according to an embodiment of the present invention.

Referring to FIG. 2, a controller 11 controls a general operation of the navigation terminal 70 and in particular, controls an operation of sharing the position information with other navigation terminals according to the present invention. A storage unit 12 is comprised of a region for storing a control program controlling the navigation terminal; a region for temporarily storing data that is generated when the control program is executed; and a region for storing user data that is generated by a user. The storage unit 12 stores its own inherent number. The inherent number can be identical with that of the cellular phone, and can be also an electronic serial number (ESN). An input unit 13 generates a command depending on a user's request, and outputs the generated command to the controller 11. The input unit 13 can be also a key input unit, a touch pad and/or a voice recognition module.

A GPS receiver 1 7 receives the GPS signals from the GPS satellites. A map database 21 stores map data including information on a position, a name, and a parcel number of a mountain, a river, a road, and a building. The position information processor 18 receives the GPS signals from the GPS receiver 17, calculates the self position from the received GPS signals, maps the calculated self position to the map data, that is, to the position on the map, and outputs the mapped data to the controller 11. The position information processor 18 receives from the controller 11 the position information received from at least one of other navigation terminals, maps the self position together with the position information of other navigation terminals, and outputs the mapped position information to the controller 11.

A displaying unit 24 receives the map data to which the self position and/or the positions of other navigation terminals are mapped and displays the received map data in a graphic format, under the control of the controller 11.

A wireless communication unit 23 connects with the mobile communication system 30 of FIG. 1 and communicates with other navigation terminals through an antenna (ANT).

A timer 25 operates under the control of the controller 11, and counts and provides a variety of times necessary for an operation of the navigation terminal, to the controller 11.

A power source unit 26 receives a predetermined external power source, and converts the received power source into a power source necessary for each constituent component. In case where the navigation terminal is the telematics terminal, the external power source is a power source of a car battery having a voltage of 12V or 24V.

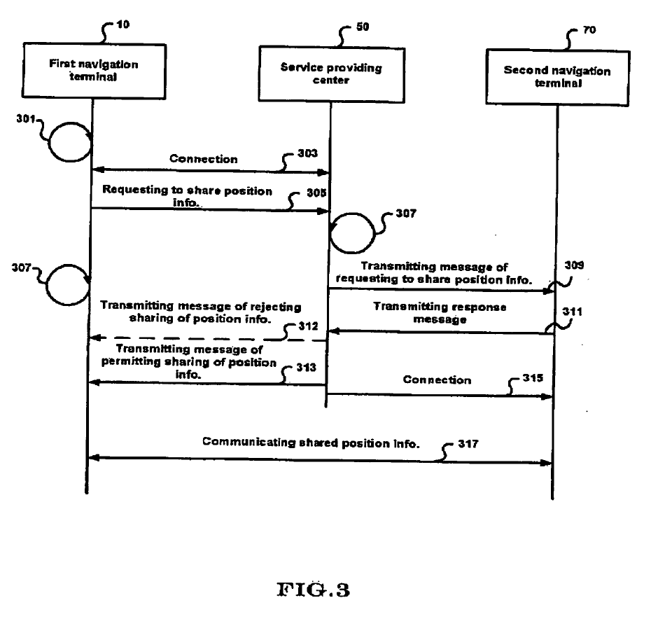

FIG. 3 is a process diagram illustrating a method for sharing the position information between two navigation terminals according to an embodiment of the present invention.

A procedure of sharing the position information between two navigation terminals (Hereinafter, the telematics terminal 10 is called a first navigation terminal, and the other navigation terminal 70 is called a second navigation terminal) will be described below with reference to FIGS. 1 to 3.

In Step 301, the first navigation terminal 10 determines whether or not receiving a position information sharing command by the user and an inherent number of a counter party's navigation terminal (that is, the second navigation terminal 70) from the input unit 13 of FIG. 2. If it is determined in the Step 301 to receive the position information sharing command and the inherent number of the second navigation terminal, the first navigation terminal 10 connects to the service providing center in Step 303. Upon connection with the service providing center 50, the first navigation terminal 10 generates and transmits the message of requesting for sharing the position information to the service providing center 50 in Step 305. The sharing request message includes the own inherent number, the inherent number of the second navigation terminal, and position information sharing request data representing that the sharing request message is to request the sharing of the position information.

Upon reception of the position information sharing request data, in Step 307, the service providing center 50 analyzes the sharing request message, searches for the corresponding second navigation terminal 70 using the inherent number of the second navigation terminal, and transmits the sharing request message to the searched second navigation terminal 70. Upon reception of the sharing request message from the first navigation terminal 10, in Step 309, the service providing center 50 can also determine whether or not the user is a subscriber, and transmit the sharing request message to the second navigation terminal 70 only when the user is determined to be the subscriber. In this case, the user should previously register the inherent number of his/her own navigation terminal 10 and user information to the service providing center 50.

Upon reception of the sharing request message from the service providing center 50, the second navigation center 70 informs the user of there existing a request for the sharing of the position information from the first navigation terminal 10. After that, if the user selects permission or rejection for the sharing of the position information, the second navigation terminal 70 transmits a response message including permission information or rejection information to the service providing center 50 in Step 311. The service providing center 50 receives and analyzes the response message. If it is analyzed to reject the sharing of the position information, the service providing center 50 transmits a message of rejecting the sharing of the position information to the first navigation terminal 10 in Step 312. If it is analyzed to permit the sharing of the position information, the service providing center 50 transmits a message of permitting the sharing of the position information in Step 313. After that, in Step 315, the service providing center 50 connects the first navigation terminal 10 with the second navigation terminal 70 so that they can communicate the shared position information through the mobile communication system 30.

Upon direct connection of the first and second navigation terminals 10 and 70 in the Step 315, the first and second navigation terminals 10 and 70 mutually communicate each of their own shared position information in Step 317.

Also, only the first navigation terminal 10 or the second navigation terminal 70 can just only transmit or receive the shared position information. In an exemplary description, the navigation terminal of the preceding vehicle does not display a position of the following vehicle, and the navigation terminal of the following vehicle displays its own position together with all positions of the preceding vehicles. This can be usefully used for chasing a criminal vehicle, a cash transit vehicle, or the like. For this, the position information sharing request message should include information representing the sharing of the position information, and except for a specific circumstance, that is, except for a specific case of chasing the criminal vehicle or the cash transit vehicle, it is desirable that the position information is shared only under the permission of the navigation terminal that displays only the self position.

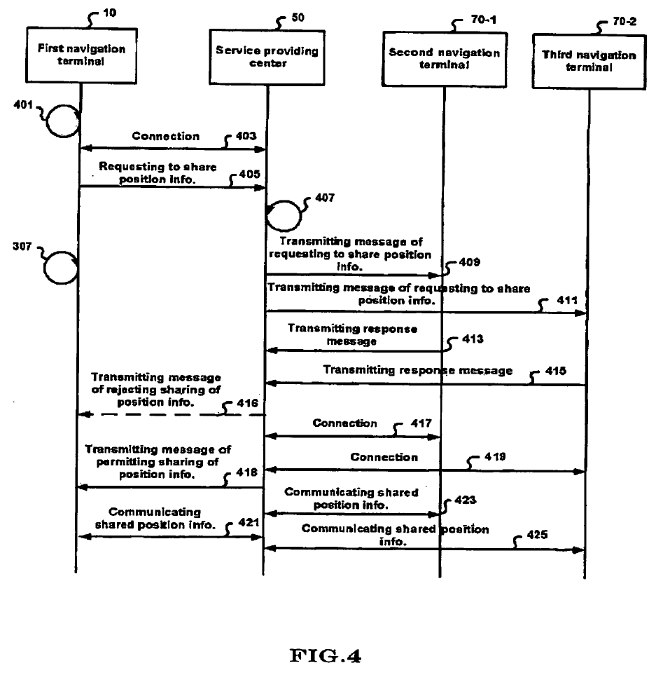

A case where three navigation terminals are provided will be described with reference to FIG. 4 below.

FIG. 4 is a process diagram illustrating a method for sharing the position information between at least three navigation terminals according to an embodiment of the present invention.

Steps 401 to 407 of FIG. 4 are the same as the Steps 301 to 307 of FIG. 3. However, in FIG. 3, the sharing request message is transmitted only to one second navigation terminal 70, but in FIG. 4, the sharing request message is transmitted to second and third navigation terminals 70-1 and 70-2 in Steps 409 and 411, respectively. Accordingly, the sharing request message received from the first navigation terminal 10 should have inherent numbers of all the second and third navigation terminals 70-1 and 70-2. If so, the service providing center 50 can transmit the sharing request message to the second and third navigation terminals 70-1 and 70-2.

In FIG. 3, if there is a mutual permission, that is, a mutual authentication between the first and second navigation terminals 10 and 70, the shared position information is communicated between the navigation terminals 10 and 70. However, in FIG. 4, three navigation terminals are provided and therefore, the shared position information received from each of the navigation terminals should be switched. Therefore, the shared position information is not communicated between the navigation terminals but is communicated between the navigation terminals through the service providing center 50. In other words, if the service providing center 50 receives the response message of permitting the sharing of the position information from each of the navigation terminals 10, 70-1, and 70-2, it collects the shared position information from each of the navigation terminals 10, 70-1, and 70-2, and transmits all shared position information excluding its own shared position information to the corresponding navigation terminals 10, 70-1, and 70-2. For example, assuming that the first, second, and third navigation terminals 10, 70-1 and 70-2 have first, second, and third shared position information respectively, the service providing center 50 receives the first, second and third shared position information from the first, second and third navigation terminals 10, 70-1 and 70-2, respectively, and transmits the second and third shared position information to the first navigation terminal 10, and transmits the first and third shared position information to the second navigation terminal 70-1, and transmits the first and second shared position information to the third navigation terminal 70-2.

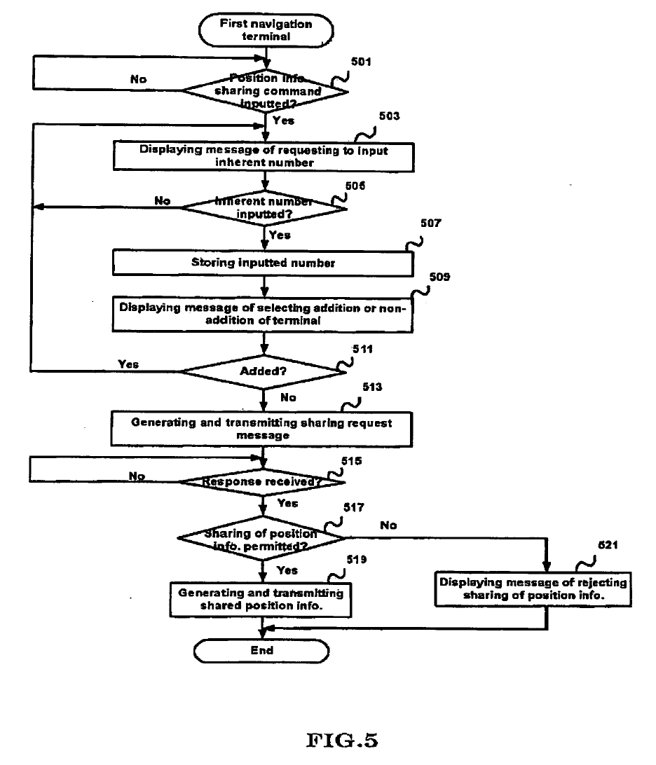

FIG. 5 is a flowchart illustrating a method of sharing the position information in the navigation terminal that requests for the sharing of the position information according to an embodiment of the present invention.

Referring to FIG. 5, first, in Step 501, the controller 11 determines whether or not receiving the position information sharing command by the user, from the input unit 13. Upon reception of the position information sharing command from the input unit 13, in Step 503, the controller 11 displays a message of requesting to input the inherent number of the navigation terminal, which is to share the position information, on a displaying unit 24. After that, in Step 505, the controller 11 determines whether or not receiving the inherent number from the input unit 13 in response to the request to input the inherent number. If the inherent number is determined to be inputted in the Step 505, the controller 11 stores the inherent number in Step 507, and displays a message of selecting addition or non-addition of the navigation terminal on the displaying unit 24 in order to inquire of the user as to whether or not further adding the navigation terminal that is to share the position information in Step 509, and determines whether or not selecting the addition of the navigation terminal in Step 511. If it is determined to select the addition of the navigation terminal, the controller 11 returns to the Step 503 and repeatedly performs the Steps 503 to 511 until there is not generated the addition of the navigation terminal in the Step 511. The inherent numbers inputted through the Steps 503 to 511 are sequentially stored in the storage unit 12. The added navigation terminals are not limited in number but are preferably determined in consideration of a transfer rate of network data.

After that, in Step 513, the controller 11 generates and transmits the position information sharing request message that includes its own inherent number, at least one inherent number inputted in the Steps 503 to 511, and the position information sharing request data representing that the sharing request message is to request the sharing of the position information, to the mobile communication system 30 through the wireless communication unit 23 and the antenna (ANT).

After transmitting the position information sharing request message, in Step 515, the controller 11 determines whether or not receiving the response message responsive to the sharing request message. Upon reception of the response message in the Step 515, the controller 11 determines whether the response message is a message of permitting or rejecting the sharing of the position information in Step 517. If it is determined to be the message of permitting the sharing of the position information, in Step 519, the controller 11 controls the position information processor 18 to detect a position and transmit the shared position information including detected position information, to the mobile communication system 30 through the wireless communication unit 23 and the antenna (ANT). However, if the response message is determined to be the message of rejecting the sharing of the position information through the Step 517, in Step 521, the controller 11 displays the message of rejecting the sharing of the position information on the displaying unit 24, and informs that the request for the sharing of the position information is rejected.

The shared position information includes not only the detected self position information but also path information set by the user.

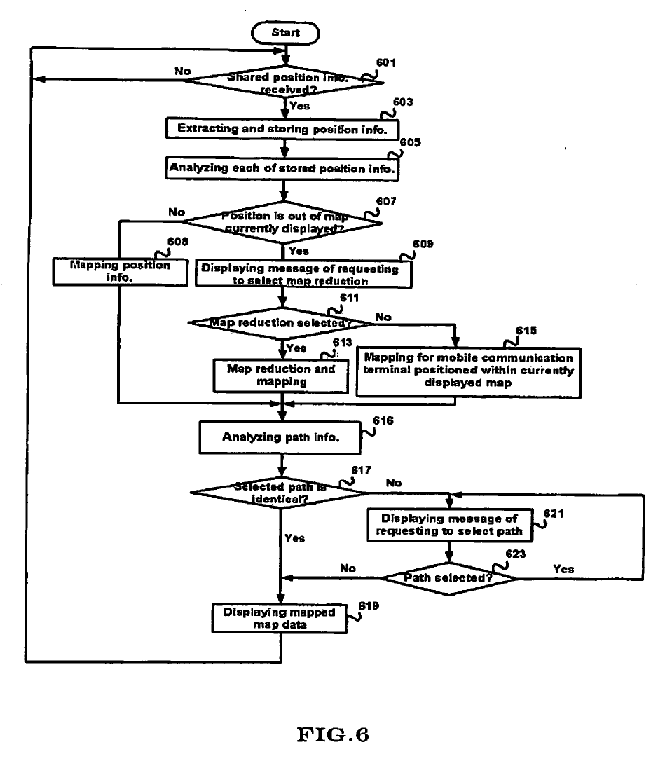

At the same time of beginning to transmit the shared position information, the controller 11 receives the shared position information from the navigation terminals that request for the sharing of the position information through the wireless communication unit 23. A procedure of receiving and processing the shared position information will be described with reference to FIG. 6 below.

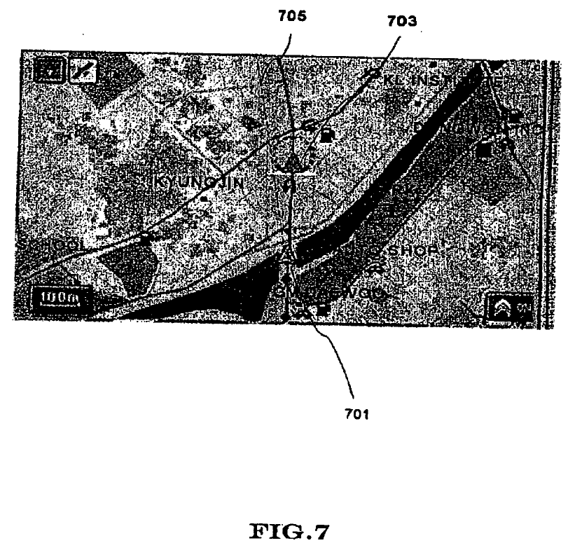

FIG. 6 is a flowchart illustrating a method for displaying the positions of the plurality of navigation terminals in the navigation terminal according to an embodiment of the present invention, and FIG. 7 illustrates an example of displaying the positions of the plurality of navigation terminals, depending on the shared position information, on the displaying unit of the navigation terminal according to an embodiment of the present invention.

Referring to the drawings, in Step 601, the controller 11 determines whether or not receiving the shared position information from other navigation terminals. Upon receiving of the shared position information through the wireless communication unit 23 in the Step 601, the controller 11 extracts the position information and the path information of each navigation terminal, and stores the extracted information in the storage unit 12 in Step 603. After that, the controller 11 reads and analyzes the stored position information in Step 605, and determines whether or not the position of the position information is within a map currently displayed on the displaying unit 24 in Step 607. This can be different depending on a scale of the map currently displayed on the displaying unit 24. If it is determined that all navigation terminals are positioned within the map currently displayed in the Step 607, Step 608 is performed. If the navigation terminal is determined in position to be out of the map, Step 609 is performed.

In the Step 608, the controller 11 maps the position information to the map and displays the mapped position information on the displaying unit 24. In the Step 609, the controller 11 displays a message of requesting to select a map reduction. After displaying the message of requesting to select the map reduction, the controller 11 determines whether or not the map reduction is selected in Step 611. When it is determined to select the map reduction, Step 613 is performed, and when it is determined not to select the map reduction, Step 615 is performed.

In the Step 613, the controller 11 reduces the map in scale, maps the position information, and displays the mapped position information on the displaying unit 24. In the map reduction, the controller 11 can reduce the map on a predetermined scale basis, or can reduce the map at one time in scale so that the navigation terminal being out of the map can be displayed in position on the displaying unit 24. On the contrary, in the Step 615, the controller 11 performs mapping only for the navigation terminals being within the currently displayed map, and displays the mapped result on the displaying unit 24. Though not illustrated in the drawings, as shown by a dotted line 705 of FIG. 7, the out-of-range navigation terminal can be also displayed in position by drawing the dotted line 705 from the self position of the navigation terminal 701 to a position of the out-of-range navigation terminal so that the user can recognize whether the out-of-range navigation terminal is in any direction. Further, a distance to the out-of-range navigation terminal can be also displayed in the dotted line 705.

FIG. 7 illustrates a case where the position information is shared between three navigation terminals, and illustrates the navigation terminal 701 showing the self position, the navigation terminal 703 being within the displayed map, and the dotted line 705 showing only a direction of the out-of-range navigation terminal.

After the Step 613 or 615, the controller 11 analyzes the stored path information of each navigation terminal in Step 616, and determines whether or not the path information are identical in Step 617. In other words, the controller 11 determines whether or not paths of three navigation terminals each set by the users are identical. If it is determined to be identical as the determination result, the controller 11 displays the map to which the path information is mapped, on the displaying unit 24 in Step 619.

However, if the selected paths of the navigation terminals are different, the controller 11 displays the map to which other all path information are mapped, on the displaying unit 24, and displays a message of requesting to select any one of the plurality of displayed paths on the displaying unit 24 in Step 621. After that, the controller 11 determines whether or not selecting one path in Step 623. If it is determined to select one path in the Step 623, the controller 11 maps and displays the selected path on the map in the Step 619. The path selected by the navigation terminal requesting for the sharing of the position information can be set as aforementioned. Further, upon transmitting of the shared position information, the selected path is transmitted to other navigation terminals, including the path information and information representing that the path information is information on the selected path. The other navigation terminals receive and confirm the information representing that the path information is the information on the selected path, and set paths as the paths of the path information. Further, the path can be set even through voting, and the voting result is transmitted to all navigation terminals. The path of the navigation terminal obtaining the number of many votes can be also selected and set.

As described above, the present invention has an advantage in that, when the users ride and move on a plurality of cars to the same destination, the positions of other cars as well as that of his/her own car can be displayed so that the users can recognize whether or not other vehicles are running at any region on the path to the destination, and can do collective actions even when riding and moving on the plurality of cars.

Further, the present invention has an advantage in that the times taken to arrive at the destination are prevented from being different due to that the vehicles select the different paths respectively when setting the paths.

Furthermore, the present invention has an advantage in that owing to its application to searching for a theft vehicle and tracking a criminal vehicle, the theft vehicle can be quickly searched, and a running path of the criminal vehicle can be previously recognized, thereby being helpful for a quick arrest.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A position information sharing system using a mobile communication system, the system comprising:
a plurality of navigation terminals for wirelessly communicating with the mobile communication system, receiving shared position information of at least one navigation system through the mobile communication system, mapping a self position and a position based on the received position information to map data, and displaying the mapped positions; and
a service providing center for performing authentication for sharing of position information between the plurality of navigation terminals, receiving the shared position information from each of the navigation terminals when the authentication is made, and transmitting the received position information to the corresponding navigation terminals.

2. The system according to claim 1, wherein the shared position information has information on a position and a path on a map of the corresponding navigation terminal.

3. The system according to claim 2, wherein a predetermined one of the navigation terminals receives path information from other navigation terminals, compares self path information with the received path information, and transmits the self path information to other navigation terminals to set one unified path when it is determined as the comparison result to be different.

4. The system according to claim 2, wherein a predetermined one of the navigation terminals receives path information from other navigation terminals, compares self path information with the received path information, selects a path of a navigation terminal requesting for sharing the position information among the navigation terminals when it is determined as the comparison result to be different, and transmits path information to other navigation terminals to set one unified path.

5. A position information sharing system using a mobile communication system, the system comprising:
a plurality of navigation terminals for wirelessly communicating with the mobile communication system, communicating shared position information of at least one navigation system through the mobile communication system, mapping a self position and a position based on the received position information to map data, and displaying the mapped positions; and
a service providing center for performing authentication for sharing of position information between the plurality of navigation terminals, and connecting and controlling the navigation terminals to communicate their shared position information when the authentication is made.

6. The system according to claim 5, wherein the shared position information has information on a position and a path on a map of the corresponding navigation terminal.

7. The system according to claim 6, wherein a predetermined one of the navigation terminals receives path information from other navigation terminals, compares self path information with the received path information, and transmits the self path information to other navigation terminals to set one unified path when it is determined as the comparison result to be different.

8. The system according to claim 6, wherein a predetermined one of the navigation terminals receives path information from other navigation terminals, compares self path information with the received path information, selects a path of a navigation terminal requesting for sharing the position information among the navigation terminals when it is determined as the comparison result to be different, and transmits path information to other navigation terminals to set one unified path.

9. A navigation terminal of a position information sharing system using a mobile communication system, the terminal having a displaying unit and communicating shared position information having position information and path information between a plurality of navigation terminals, using the mobile communication system, the terminal comprising:
a wireless communicating unit for communicating the shared position information;
a GPS (global positioning system) receiver for receiving a GPS satellite signal;
a map database for storing map data;
a position information processor for receiving the GPS satellite signals under a predetermined control to calculate a self position, separating and analyzing the position information and the path information from at least one of the received shared position information, and mapping the self position and a position based on the received position information to the map data; and
a controller for controlling the position information processor to receive and display the mapped data on the displaying unit.

10. A position information sharing method using a mobile communication system, the system having at least two navigation terminals for communicating shared position information and a service providing center for controlling authentication between the navigation terminals, the method comprising the steps of:
in a predetermined first one of the navigation terminals, transmitting a position information sharing message that has a self inherent number and inherent numbers of second navigation terminals other than the first navigation terminal, to the service providing center through the mobile communication system;
in the service providing center, receiving the position information sharing message, detecting the inherent numbers of the second navigation terminals, and transmitting the position information sharing message to the second navigation terminals having the inherent numbers;
in each of the second navigation terminals, receiving the position information sharing message, and when a user gives permission to share the position information, transmitting a response message responsive to the permission, to the service providing center; and
in the service providing center, upon reception of the response message, controlling and connecting the first navigation terminal and the second navigation terminals to transmit the shared position information between the first navigation terminal and the second navigation terminals.
